(19) United States
(12) Patent Application Publication
(10) Pub. No.: US 2010/0021680 A1
(43) Pub. Date: Jan. 28, 2010

(54) ANTI-DUST APPARATUS FOR LIQUID CRYSTAL DISPLAY (LCD) PANEL

(75) Inventors: CHIN-WEN LO, Taichung City (TW); YUEH-FANG WANG, Taichung City (TW); CHIA-NING KAO, Taichung City (TW)

Correspondence Address: WPAT, PC;INTELLECTUAL PROPERTY ATTORNEYS, 7225 BEVERLY ST., ANNANDALE, VA, 22003, US

(73) Assignee: WINTEK CORPORATION, TAICHUNG (TW)

(21) Appl. No.: 12/178,036

(22) Filed: Jul. 23, 2008

(51) Int. Cl. B32B 5/00

(52) U.S. Cl. 428/98

(57) ABSTRACT

An anti-dust apparatus for a liquid crystal display (LCD) panel, comprising: a protective film comprising a main portion, a foldable portion extending from the main portion, and a fold line between the main portion and the foldable portion, wherein the main portion has a first attachment surface and an exposed surface on both sides, the foldable portion has a second attachment surface adjacent to the first attachment surface, and the foldable portion is folded along the fold line to be parallel with the LCD panel; an adhesive layer disposed on the first attachment surface and the second attachment surface of the protective film, wherein the adhesive layer on the first attachment surface is attached onto the LCD panel; a twin adhesive layer disposed on the other surface different from the second attachment surface of the foldable portion, wherein the twin adhesive layer is attached onto the exposed surface of the protective film; and an anti-dust portion disposed on the adhesive layer on the second attachment surface of the foldable portion. Thereby, the present invention prevents the protective film from being mal-functional due to exposure of the adhesive layer when the foldable portion is folded.

### BACKGROUND OF THE INVENTION

1. Field of the Invention

The present invention generally relates to an anti-dust apparatus for a liquid crystal display (LCD) panel and, more particularly, to an anti-dust apparatus for a LCD panel with anti-dust protection on the foldable tag to prevent the adhesive from being exposed.

2. Description of the Prior Art

With the rapid development in technology and elevated living standard, the design of consumer electronics devices including portable computers, portable gaming devices smart phones and the like has become more and more diverse with shorter life cycle. Recently, consumer electronics devices having a large-size display have attracted tremendous attention and therefore, surface protection techniques such as anti-scratch and anti-dust have become more and more important.

The currently available protective film provides anti-scratch and anti-dust protections to prevent the LCD panel or the lens from contaminations. Usually, a general protective film is provided with a foldable tag extending outwards. The foldable tag is used for facilitating the same to be ripped off and thus preventing any unwanted residue to be left on the liquid crystal display module after the protective film had been removed.

As shown in FIG. 1A and FIG. 1B, a conventional protective film 10 is provided with a foldable tag 11 extending outward. A fold line 12 is provided between the protective film 10 and the foldable tag 11 so that the foldable tag 11 is folded and attached onto the protective film 10. An adhesive layer 13 is coated on the bottom surface of the protective film 10 and the foldable tag 11. A twin adhesive layer 14 is disposed on the foldable tag 11. The twin adhesive layer 14 is covered by a release paper 15. In other words, the twin adhesive layer 14 and the release paper 15 are formed in order on the foldable tag 11. The release paper 15 is ripped off from the twin adhesive layer 14 when the foldable tag 11 is folded and attached onto the protective film 10 so that the twin adhesive layer 14 is attached to the protective film 10 to hold the foldable tag 11. However, when the foldable tag 11 is folded and attached onto the protective film 10, the adhesive layer 13 may be exposed to the moisture and dust to cause degeneration.

### SUMMARY OF THE INVENTION

It is one object of the present invention to provide an anti-dust apparatus for a LCD panel with an anti-dust portion on the foldable tag to prevent the adhesive from being exposed to the air to cause degeneration.

In order to achieve the foregoing object, the present invention provides an anti-dust apparatus for a liquid crystal display (LCD) panel, comprising: a protective film comprising a main portion, a foldable portion extending from the main portion, and a fold line between the main portion and the foldable portion, wherein the main portion has a first attachment surface and an exposed surface on both sides, the foldable portion has a second attachment surface adjacent to the first attachment surface, and the foldable portion is folded along the fold line to be parallel with the LCD panel; an adhesive layer disposed on the first attachment surface and the second attachment surface of the protective film, wherein the adhesive layer on the first attachment surface is attached onto the LCD panel; a twin adhesive layer disposed on the other surface different from the second attachment surface of the foldable portion, wherein the twin adhesive layer is attached onto the exposed surface of the protective film; and an anti-dust portion disposed on the adhesive layer on the second attachment surface of the foldable portion.

### BRIEF DESCRIPTION OF THE DRAWINGS

The objects, spirits and advantages of the preferred embodiments of the present invention will be readily understood by the accompanying drawings and detailed descriptions, wherein:

FIG. 1A is a top view of a conventional protective film;

FIG. 1B is a cross-sectional view along X-X of a conventional protective film;

FIG. 2A is a top view of a protective film according to the first embodiment of the present invention;

FIG. 2B is a cross-sectional view along Y-Y of a protective film according to the first embodiment of the present invention;

FIG. 2C is a cross-sectional view of a foldable portion folded and attached onto the main portion according to FIG. 2B;

FIG. 3A is a top view of a protective film according to the second embodiment of the present invention;

FIG. 3B is a cross-sectional view along Y-Y of a protective film according to the second embodiment of the present invention; and

FIG. 3C is a cross-sectional view of a foldable portion folded and attached onto the main portion according to FIG. 3B.

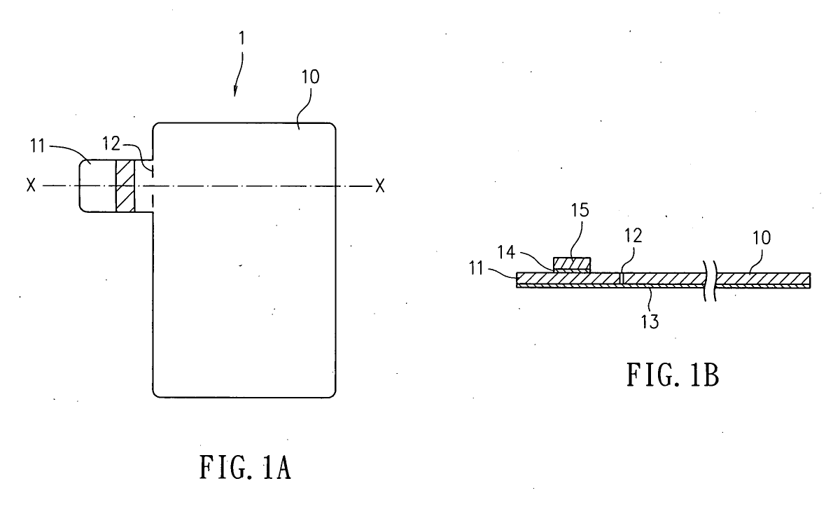

### DETAILED DESCRIPTION OF THE PREFERRED EMBODIMENTS

The present invention providing a micro reflection-type liquid crystal display can be exemplified by the preferred embodiments as described hereinafter.

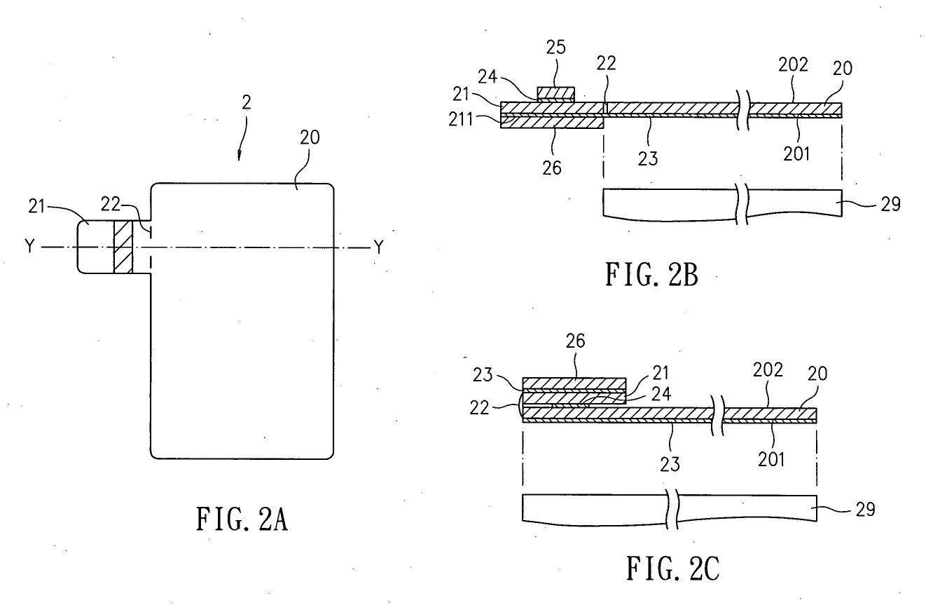

Referring to FIG. 2A and FIG. 2B, a top view and a cross-sectional view along Y-Y of a protective film according to the first embodiment of the present invention are shown. The present invention provides an anti-dust apparatus for a liquid crystal display (LCD) panel. The anti-dust apparatus comprises: a protective film 2 comprising a main portion 20, a foldable portion 21 extending from the main portion 20, and a fold line 22 between the main portion 20 and the foldable portion 21. The foldable portion 21 is disposed on one side of the main portion 20. The fold line 22 comprises a plurality of discrete holes. Alternatively, the fold line 22 is a notation line. The protective film 2 is transparent. The main portion 20 has a first attachment surface 201 and an exposed surface 202 on both sides. The foldable portion 21 has a second attachment surface 211 adjacent to the first attachment surface 201. The first attachment surface 201 and the second attachment surface 211 are at the same horizontal level.

An adhesive layer 23 is disposed on the first attachment surface 201 and the second attachment surface 211 of the protective film 2 so that the adhesive layer 23 on the first attachment surface 201 is attached onto a LCD panel 29. A twin adhesive layer 24 is disposed on the other surface different from the second attachment surface 211 of the foldable portion 21. The twin adhesive layer 24 is attached onto the exposed surface 202 of the protective film 2. A release paper 25 is further provided on the twin adhesive layer 24. The release paper 25 is water-proof and anti-dust.

An anti-dust portion 26 is disposed on the adhesive layer 23 on the second attachment surface 211 on the foldable portion 21. The anti-dust portion 26 is formed as a sheet capable of covering the adhesive layer 23 on the foldable portion 21. It is preferable that the anti-dust portion 26 is cut flush with the fold line 22.

When the foldable portion 21 is folded along the fold line 22 to be attached onto the exposed surface 202 of the main portion 20 and parallel with the LCD panel 29, the release paper 25 can be removed, as shown in FIG. 2C. Meanwhile, the twin adhesive layer 24 is attached onto the exposed surface 202 so that the foldable portion 21 is folded and attached onto the main portion 20. Thereby, the anti-dust portion 26 prevents the adhesive layer 23 on the foldable portion 21 from being exposed to the air.

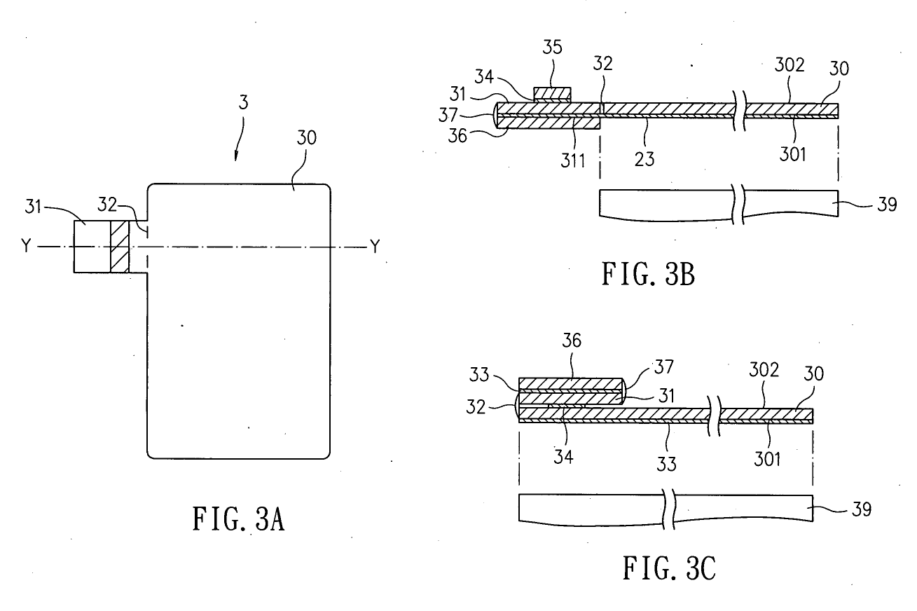

Referring to FIG. 3A and FIG. 3B, a top view and a cross-sectional view along Z-Z of a protective film according to the second embodiment of the present invention are shown. The anti-dust apparatus for a liquid crystal display (LCD) panel of the present invention comprises: a protective film 3 comprising a main portion 30, a foldable portion 31 extending from the main portion 30, and a fold line 32 between the main portion 30 and the foldable portion 31. The foldable portion 31 is disposed on one side of the main portion 30. The fold line 32 comprises a plurality of discrete holes. The protective film 3 is transparent. The main portion 30 has a first attachment surface 301 and an exposed surface 302 on both sides. The foldable portion 31 has a second attachment surface 311 adjacent to the first attachment surface 301. The first attachment surface 301 and the second attachment surface 311 are at the same horizontal level.

An adhesive layer 33 is disposed on the first attachment surface 301 and the second attachment surface 311 of the protective film 3 so that the adhesive layer 33 on the first attachment surface 301 is attached onto a LCD panel 39. A twin adhesive layer 34 is disposed on the other surface different from the second attachment surface 311 of the foldable portion 31. The twin adhesive layer 34 is attached onto the exposed surface 302 of the protective film 3. A release paper 35 is further provided on the twin adhesive layer 34. The release paper 35 is water-proof and anti-dust.

An anti-dust portion 36 is disposed on the adhesive layer 33 on the second attachment surface 311 on the foldable portion 31. The anti-dust portion 36 is formed as a sheet capable of covering the adhesive layer 33 on the foldable portion 31. The anti-dust portion 36 extends from the foldable portion 31. The anti-dust portion 36 and the foldable portion 31 are formed in the same process. The anti-dust portion 36 and the foldable portion 31 are of the same size. A fold line 37 is formed between the foldable portion 31 and the anti-dust portion 36 so that the anti-dust portion 36 is foldable and attached onto the adhesive layer 33 on the second attachment surface 311. Therefore, the anti-dust portion 36 and the foldable portion 31 are attached onto each other completely.

It is preferable that the anti-dust portion 36 is cut flush with the fold line 32. When the foldable portion 31 is folded along the fold line 32 to be attached onto the exposed surface 302 of the main portion 30 and parallel with the LCD panel 39, the release paper 35 can be removed, as shown in FIG. 3C. Meanwhile, the twin adhesive layer 34 is attached onto the exposed surface 302 so that the foldable portion 31 is folded and attached onto the main portion 30. Thereby, the anti-dust portion 36 prevents the adhesive layer 33 on the foldable portion 31 from being exposed to the air.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An anti-dust apparatus for a liquid crystal display (LCD) panel, comprising:
a protective film comprising a main portion, a foldable portion extending from the main portion, and a fold line between the main portion and the foldable portion, wherein the main portion has a first attachment surface and an exposed surface on both sides, the foldable portion has a second attachment surface adjacent to the first attachment surface, and the foldable portion is folded along the fold line to be parallel with the LCD panel;
an adhesive layer disposed on the first attachment surface and the second attachment surface of the protective film, wherein the adhesive layer on the first attachment surface is attached onto the LCD panel;
a twin adhesive layer disposed on the other surface different from the second attachment surface of the foldable portion, wherein the twin adhesive layer is attached onto the exposed surface of the protective film; and
an anti-dust portion disposed on the adhesive layer on the second attachment surface of the foldable portion.

2. The anti-dust apparatus as recited in claim 1, wherein the anti-dust portion and the foldable portion are formed in the same process and are attached onto each other completely.

3. The anti-dust apparatus as recited in claim 1, wherein the protective film is transparent.

4. The anti-dust apparatus as recited in claim 1, wherein the anti-dust portion is formed as a sheet.

5. The anti-dust apparatus as recited in claim 1, wherein the fold line comprises a plurality of discrete holes.

6. The anti-dust apparatus as recited in claim 1, wherein the fold line is a notation line.

7. The anti-dust apparatus as recited in claim 1, wherein the anti-dust portion is cut flush with the fold line.
